(19) United States
(12) Patent Application Publication
(10) Pub. No.: US 2005/0036080 A1
(43) Pub. Date: Feb. 17, 2005

(54) Thin film transistor, active matrix substrate, display device, and electronic apparatus

(75) Inventor: Shin Koide, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/882,279

(22) Filed: Jul. 2, 2004

(30) Foreign Application Priority Data
Jul. 18, 2003 (JP) 2003-277136
Apr. 23, 2004 (JP) 2004-127734

(51) Int. Cl. G02F 1/136

(52) U.S. Cl. 349/43

(57) ABSTRACT

To provide a thin film transistor with off current reduced to a very low level and excellent reliability, which can be applied to a pixel driving element or a peripheral circuit of an ultra high-precision display device, an active matrix substrate including the thin film transistor, and a display device including the active matrix substrate, a thin film transistor according includes a semiconductor layer provided on a substrate body, a gate electrode, a drain electrode, and a source electrode, wherein the semiconductor layer including a high-concentration drain region which is connected to the drain electrode and which is highly doped with an impurity; a low-concentration drain region which is provided at the gate electrode side of the high-concentration drain region and which is lightly doped with an impurity; and an offset region which is a region slightly doped with an impurity, or an intrinsic semiconductor region, the offset region being provided at the gate electrode side of the low-concentration drain region.

### BACKGROUND OF THE INVENTION

1. Field of Invention

The present invention relates to a thin film transistor, an active matrix substrate, a display device, and an electronic apparatus.

2. Description of Related Art

Some related art display devices, such as liquid crystal display devices, have enhanced brightness and precision. For example, this technology is relevant for the digitalization of photographs. In addition, this technology is relevant for display devices with which vivid images can be viewed similarly to photographs without requiring printing. However, such related art ultra high-precision display devices do not realize the accuracy of photographs. This is mainly because the current of transistors used in pixels cannot be reduced.

The related art makes semiconductor layers of thin film transistors of liquid crystal display devices out of amorphous silicon, out of low-temperature polysilicon films, and out of high-temperature polysilicon films. Because the related art method of making the semiconductor layers out of low-temperature polysilicon films is advantageous in that an image signal supply circuit can be implemented at the peripheries of pixels and a large-sized glass substrate can be utilized, the method of making the semiconductor layers out of low-temperature polysilicon films will most probably realize an ultra high-precision liquid crystal panel. However, since the low-temperature polysilicon film has many defects, the off current thereof is usually very large. Since the off current thereof is the largest among the aforementioned three methods, there is a problem that the method of making the semiconductor layers out of low-temperature polysilicon films is not suitable for the ultra high-precision liquid crystal panel in that point.

Therefore, in order to reduce the off current of the thin film transistors, the related art provides a LDD type junction structure, as in LSI technologies, or an offset structure in which a junction portion is protruded outwardly from an edge portion of a gate electrode as viewed two-dimensionally. See Japanese Unexamined Patent Application Publication No. 11-177097.

### SUMMARY OF THE INVENTION

By constructing thin film transistors having the LDD structure, it is possible to reduce the off current, which is increased with increase of the gate voltage. However, in an ultra high-precision display device, since the liquid crystal capacity is decreased proportionally to areas of pixels and thus the retention characteristic is deteriorated, it is difficult to suppress deterioration of the retention characteristic only through reduction of the off current by the LDD structure.

Further, in the thin film transistors having the offset structure, it is possible to obtain a better characteristic in off current than that of the thin film transistors having the LDD structure. But there is deterioration in characteristics due to hot carriers, so that there is a problem that it is difficult to secure reliability thereof.

An exemplary aspect of the present invention addresses the above and/or other problems. An exemplary aspect of the present invention provides a thin film transistor with off current reduced to a very low level and excellent reliability, which can be applied to a pixel driving element or a peripheral circuit of an ultra high-precision display device, an active matrix substrate including the thin film transistor, and a display device including the active matrix substrate.

In order to address or accomplish the above, an exemplary aspect of the present invention provides a thin film transistor including a semiconductor layer provided on an insulating substrate, a gate electrode, a drain electrode, and a source electrode. The drain electrode and the source electrode are connected to the semiconductor layer. The semiconductor layer includes a high-concentration impurity region which is connected to the drain electrode and which is highly doped with an impurity; a low-concentration impurity region which is provided at the gate electrode side of the high-concentration impurity region and which is lowly doped with an impurity; an offset region which is a region slightly doped with an impurity or which is an intrinsic semiconductor region, the offset region being provided at the gate electrode side of the low-concentration impurity region.

According to the above construction, by providing the offset region, defects in the vicinity of the gate are reduced. Thus the off current can be reduced. Further, since the concentration of electric field in the vicinity of the drain is mitigated due to the low-concentration impurity region provided outwardly (at the electrode side) from the offset region, it is difficult to cause the hot carrier deterioration, which was a problem of the related art transistor having the offset structure. As a result, it is possible to realize the thin film transistor with high performance and high reliability, in which the off current is more reduced than that of the related art thin film transistor having the offset structure and it is more difficult to cause the hot carrier deterioration than in the related art thin film transistor having the LDD structure.

The thin film transistor according to an exemplary aspect of the present invention may be of an N channel type in which the high-concentration impurity region is highly doped with N type impurities. The low-concentration impurity region is lowly doped with N type impurities. The offset region is slightly doped with P type impurities or the intrinsic semiconductor region.

Further, the thin film transistor according to an exemplary aspect of the present invention may be of a P channel type in which the high-concentration impurity region is highly doped with P type impurities. The low-concentration impurity region is lowly doped with P type impurities. The offset region is slightly doped with N type impurities or the intrinsic semiconductor region.

According to the above constructions, regardless of N channel type or P channel type, it is possible to secure reliability of the thin film transistor while reducing leak current thereof.

The thin film transistor according to an exemplary aspect of the present invention may further include a second gate electrode which is connected electrically to the gate electrode and covers two-dimensionally the offset region of the semiconductor layer.

In this construction, the second gate electrode may be formed inwardly from the high-concentration impurity region.

According to the above construction, since the region including the offset region or the low-concentration impurity region can be activated to some extent by the electric field from the second gate electrode, it is possible to enhance the on current characteristic of the thin film transistor. As a result, even when the length in a TFT working direction of the offset region or the low-concentration impurity region is increased due to, for example, production deviation, it is possible to implement the thin film transistor in which the on current deterioration occurs difficultly.

The second gate electrode may be provided at the opposite side of the semiconductor layer about the gate electrode. In this construction, the second gate electrode and the gate electrode may be constructed such that an insulating film is interposed between both gate electrodes and both gate electrodes are electrically connected to each other through a contact hole provided in the insulating film.

The thin film transistor according to an exemplary aspect of the present invention may include a plurality of the gate electrodes. The thin film transistor according to an aspect of the present invention may have a multi gate structure. According to this construction, since the voltages at both sides of one gate can be reduced, it is possible to further reduce the off current.

Next, an active matrix substrate according to an exemplary aspect of the present invention includes the thin film transistor according to an exemplary aspect of the present invention described above. According to this construction, since a thin film transistor provided as a pixel switching element or a peripheral circuit element may be the thin film transistor according to an exemplary aspect of the present invention, it is possible to provide an active matrix substrate having an excellent pixels retention characteristic, having switching elements excellent in reliability, and being suitable for the ultra high-precision display device.

Next, a display device according to an exemplary aspect of the present invention includes the active matrix substrate according to an exemplary aspect of the present invention described above. According to this construction, it is possible to provide an ultra high-precision display device having an excellent pixels retention characteristic and excellent reliability.

The display device may include a plurality of scanning lines, a plurality of data lines, thin film transistors and pixel electrodes arranged at intersections of the plurality of scanning lines and the plurality of data lines, a data line driving circuit to supply data to the plurality of data lines, and a scanning line driving circuit to supply scanning signals to the plurality of scanning lines. The data line driving circuit may have a multiplexer circuit to selectively output image signals from one image signal line to the plurality of data lines in response to a selection signal. The thin film transistors arranged at intersections of the plurality of scanning lines and the plurality of data lines may be the thin film transistor according to an aspect of the present invention described above.

According to this construction, it is possible to reduce the number of wires of the data line driving circuit unit, so that it is easy to cope with the ultra high-precision display device. It is possible to reduce the leak current of the thin film transistors of the pixel section, which causes a problem in the ultra high-precision display device, thereby further securing reliability.

The display device may include a plurality of scanning lines, a plurality of data lines, thin film transistors and pixel electrodes arranged at intersections of the plurality of scanning lines and the plurality of data lines, a data line driving circuit to supply data to the plurality of data lines, and a scanning line driving circuit to supply scanning signals to the plurality of scanning lines. The data line driving circuit may have a multiplexer circuit to selectively output image signals from one image signal line to the plurality of data lines in response to a selection signal. A thin film transistor of the multiplexer circuit may be the thin film transistor according to an exemplary aspect of the present invention described above.

The thin film transistor according to an exemplary aspect of the present invention has high reliability. It is possible to secure reliability of the display device even when complex peripheral driving circuits are formed. Further, since the off current is small, it is possible to reduce or suppress an increase of power consumption to minimum even when complex circuits are introduced. For this reason, for example, in the data line driving circuit, the multiplexer circuit to selectively output image signals from one image signal line to the plurality of data lines in response to a selection signal can be added with no problem. Specifically, the multiplexer is effective to reduce the number of wires of the data line driving circuit unit, so that it is easy to cope with the ultra high-precision display device.

Next, an electronic apparatus according to an exemplary aspect of the present invention includes the display device according to an exemplary aspect of the present invention described above.

According to this construction, it is possible to provide an electronic apparatus including a display unit with high image quality and high precision.

### BRIEF DESCRIPTION OF THE DRAWINGS

FIG. 1 is a cross-sectional schematic illustrating a first exemplary embodiment of a thin film transistor;

FIG. 2 is a cross-sectional schematic illustrating a second exemplary embodiment of the thin film transistor;

FIGS. 3A to 3D are cross-sectional schematics illustrating processes of manufacturing the thin film transistor;

FIGS. 4A to 4C are cross-sectional schematics illustrating processes subsequent to the processes shown in FIG. 3;

FIG. 5A is a schematic illustrating a whole construction of an exemplary embodiment of a display device, and FIG. 5B is a cross-sectional schematic taken along plane H-H of FIG. 5A;

FIG. 6 is a circuit schematic of the display device shown in FIG. 5;

FIG. 7 is a schematic illustrating a pixel of the display device shown in FIG. 5;

FIG. 8 is a cross-sectional schematic taken along plane A-A′ of FIG. 7;

FIG. 9 is a circuit schematic of the display device shown in FIG. 5 including peripheral circuits;

FIG. 10 is a schematic illustrating an example of an electronic apparatus;

FIG. 11 is a cross-sectional schematic illustrating processes according to a second exemplary embodiment of a manufacturing method; and

FIG. 12 is a cross-sectional schematic illustrating processes according to the second exemplary embodiment of the manufacturing method.

### DETAILED DESCRIPTION OF EXEMPLARY EMBODIMENTS

### Thin Film Transistor

### First Exemplary Embodiment

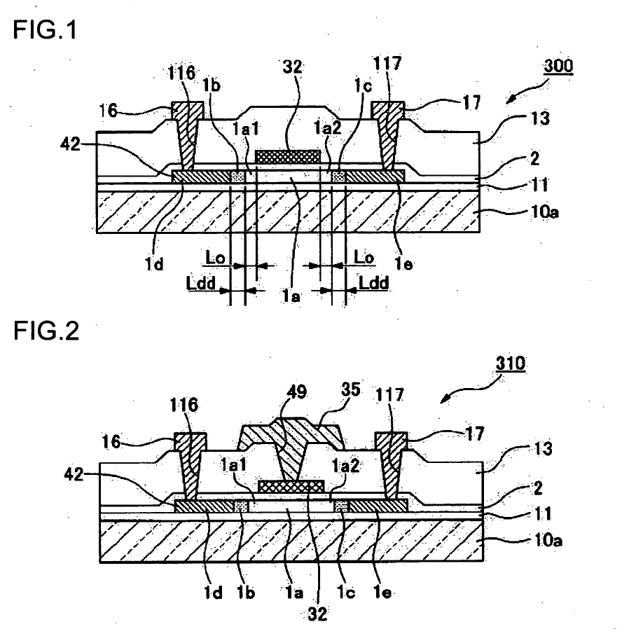

FIG. 1 is a schematic illustrating a first exemplary embodiment of a thin film transistor according to an aspect of the present invention. A TFT (Thin Film Transistor) 300 shown in FIG. 1 includes a semiconductor layer 42 made of polycrystalline silicon formed on a substrate body 10a made of insulating material, such as glass or quartz with an underlying insulating film 11 therebetween, an insulating thin film (gate insulating film) 2 formed to cover the semiconductor layer 42, a gate electrode 32, a source electrode 16, and a drain electrode 17.

The semiconductor layer 42 includes a channel region 1a opposing the gate electrode 32, offset regions 1a1, 1a2 extending from the channel region 1a, a low-concentration source region 1b, a low-concentration drain region 1c, a high-concentration source region 1d, and a high-concentration drain region 1e.

The channel region 1a and the offset regions 1a1, 1a2 are intrinsic semiconductor regions into which impurities are not implanted or minute-concentration impurity region into which impurities are implanted with minute concentration. When the impurities are implanted in the case of an N channel transistor, they may be formed of implanting boron ions with a dose of 5×10¹²/cm² or less.

The low-concentration source region 1b and the low-concentration drain region 1c are regions which is relatively lightly doped with impurities in the semiconductor layer 42. For example, in the case of the N channel transistor, they may be made by implanting phosphorous ions with a dose of about 1×10¹³/cm².

The high-concentration source region 1d and the high-concentration drain region 1e are regions which are relatively highly doped with impurities in the semiconductor layer 42. For example, in the case of the N channel transistor, they may be made by implanting phosphorous ions with a dose of about 1×10¹⁵/cm².

The TFT 300 according to this exemplary embodiment has an LDD (Lightly Doped Drain) structure in which the low-concentration impurity regions 1b, 1c and the high-concentration impurity regions 1d, 1e subsequent thereto are formed at both sides of the channel region 1a.

Further, as shown in FIG. 1, the TFT 300 according to this exemplary embodiment has a so-called offset structure including the offset region 1a1 between the channel region 1a and the low-concentration source region 1b, and the offset region 1a2 between the channel region 1a and the low-concentration drain region 1c.

The length (LDD length) Ldd of the low-concentration source region 1b and the low-concentration drain region 1c may be 0.5 μm to 1.5 μm. The length (offset length) Lo of the offset regions 1a1, 1a2 may be 0.25 μm to 1.5 μm. By limiting the LDD length Ldd and the offset length Lo to the above ranges, it was confirmed that excellent off current characteristic was obtained in the ultra high-precision display device of about 400 ppi (the number of pixels included in a length of 25.4 mm).

In the TFT (N channel) having the LDD structure, it is possible to reduce increase (leap) of the off current when the gate voltage becomes larger negatively. But the minimum value of the off current becomes rather larger than that of a self-aligned TFT. It is considered that this is because defects in the vicinity of the gate are increased by implanting impurities in the vicinity of the gate in order to form the low-concentration impurity regions. Thus, the off current flowing through the defects is increased. Unlike the implantation of impurities with high concentration, the implantation of impurities with low concentration has a feature that it is difficult to subject the defects generated due to the implantation of impurities to the self-repairing.

In the TFT having the offset structure, the off current is reduced. But in turning on the transistor, the intrinsic semiconductor region (or the minute-concentration impurity region) constituting the offset regions is activated. The electric field is concentrated between the offset regions and the high-concentration impurity regions (drain/source regions), so that there is a problem that the characteristic of the transistor is deteriorated due to generation of hot carriers from the concentration of the electric field.

In the TFT 300 according to this exemplary embodiment, the defects in the vicinity of the gate are decreased by providing the offset regions 1a1, 1a2 between the low-concentration impurity regions 1b, 1c and gate. As a result, it is possible to decrease the minimum value of the off current which caused a problem in the LDD structure. Further, since the concentration of the electric field in the vicinity of the source and drain can be mitigated by the low-concentration impurity regions 1b, 1c extending from the offset regions 1a1, 1a2, it is possible to reduce or prevent deterioration of the transistor due to the hot carriers, which caused a problem in the offset structure. Furthermore, from this construction, it is possible to obtain excellent characteristics in that the off current is more reduced than that of the thin film transistor having the related art offset structure and the deterioration due to the hot carriers is smaller than that of the thin film transistor having the related art LDD structure.

Therefore, the TFT 300 according to this exemplary embodiment having the above construction is suitable for use in an ultra high-precision display device requiring that the off current should be reduced to a very low level. By employing such a TFT 300, it is possible to realize an ultra high-precision display device of 400 ppi or more.

Furthermore, in the above exemplary embodiment, a single gate TFT having one gate electrode has been shown and described. But in another aspect of the thin film transistor according to an aspect of the present invention, a configuration in which a plurality of gate electrodes and a plurality of channel regions corresponding thereto are provided to form a so-called multi gate structure, may be suitably used. In this way, by providing a plurality of gates, the voltage between the source and drain regions sandwiching one channel region is decreased, so that it is possible to further reduce the off current.

Furthermore, in the above exemplary embodiment, the offset regions 1a1, 1a2 and the low-concentration impurity regions 1b, 1c are provided at both sides of the channel region. However, only if the offset region and the low-concentration impurity region are provided at least at the drain side, it is possible to obtain the advantages of reduction in the off current and the hot carrier deterioration, although the advantages are smaller than those of the aforementioned exemplary embodiment.

### Second Exemplary Embodiment

FIG. 2 is a schematic illustrating a second exemplary embodiment of the thin film transistor according to an aspect of the present invention. A TFT (Thin Film Transistor) 310 shown in FIG. 2 has a construction in which a wing gate electrode, (second gate electrode) 35 having a substantially T shape in a cross-sectional view and electrically connected to the gate electrode 32, is added to the TFT 300 shown in FIG. 1. The wing gate electrode 35 is formed to two-dimensionally cover the gate electrode 32 on the semiconductor layer 42 and the offset regions 1a1, 1a2 in the semiconductor layer 42. In this exemplary embodiment, the end portions in the shown horizontal direction of the wing gate electrode 35 are positioned in flat areas of the low-concentration drain region 1b and the low-concentration source region 1c of the semiconductor layer 42. Further, the wing gate electrode 35 and the gate electrode 32 are electrically connected to each other through a contact hole 49 penetrating a first interlayer insulating film 13.

In the TFT 310 according to this exemplary embodiment, since the wing gate electrode 35 is arranged on the offset regions 1a1, 1a2, as shown in FIG. 2, the electric field from the wing gate electrode 35 is applied to the offset regions 1a1, 1a2 and a part of the LDD regions (the low-concentration source region 1b and the low-concentration drain region 1c), when the TFT 310 is turned on. By of the weak electric field from the wing gate, the offset regions and the LDD regions are properly activated. Thus, it is easy to allow the on current to flow therethrough. Specifically, in the case where the offset length Lo or the LDD length Ldd is increased due to production deviation, etc. and thus the on current is easily decreased, the wing gate electrode works effectively. Further, since it is not necessary to apply a high electric field to the offset regions 1a1, 1a2 and the LDD regions 1b, 1c, it is possible to obtain high reliability.

Therefore, in the TFT 310 according to an aspect of the present invention, by providing the wing gate electrode 35, it is possible to obtain a better on current characteristic in addition to the advantages of the TFT 300 according to the first exemplary embodiment described above. It is also possible to obtain high reliability and production stability.

The wing gate electrode 35 can be formed at the same time as the forming of the source electrode 16 and the drain electrode 17. Specifically, a process, in which the contact hole 49 is opened at the same time as the forming of a source contact hole 116 and/or a drain contact hole 117 and the wing gate electrode 35 is formed at the same time as the forming of the source electrode 16 and/or the drain electrode 17, can be employed. In this way, by forming the wing gate electrode 35 at the same time as the forming of the source electrode 16 and the drain electrode 17, it is possible to manufacture the thin film transistor 310 according to this exemplary embodiment without increasing the number of processes.

### Method of Manufacturing Thin Film Transistor

### First Exemplary Embodiment

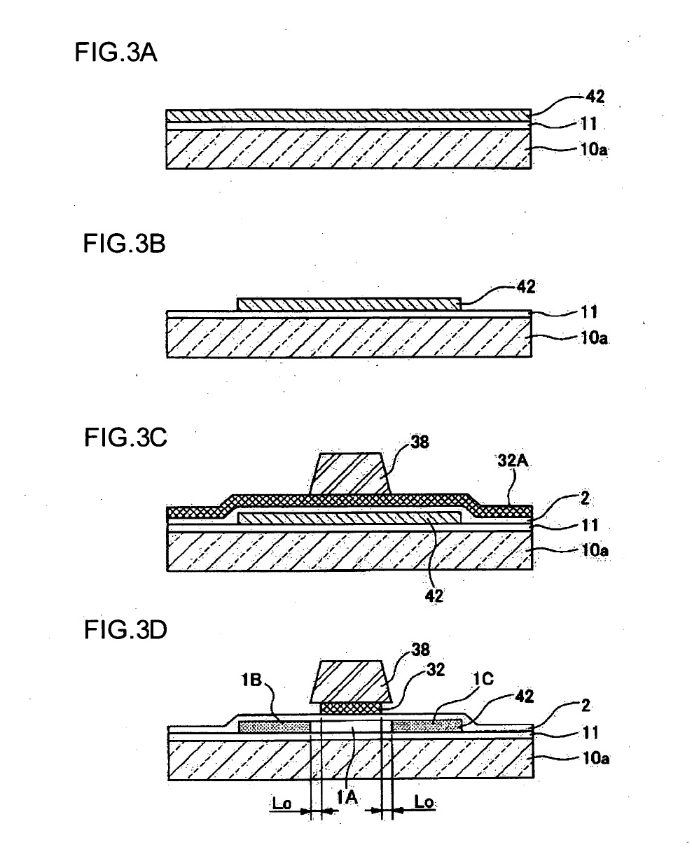

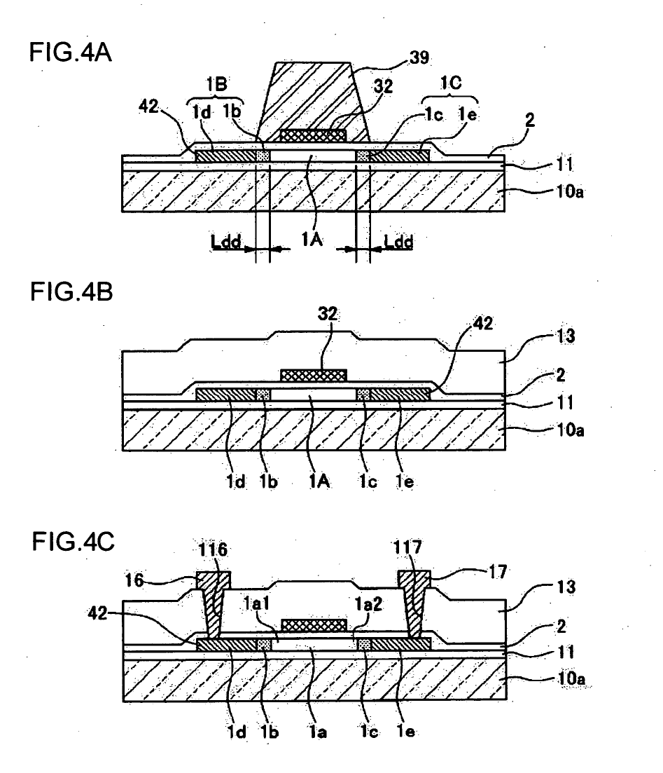

Next, a first exemplary embodiment of a method of manufacturing the thin film transistor according to an aspect of the present invention will be described. In this exemplary embodiment, a method of manufacturing the thin film transistor according to the aforementioned first exemplary embodiment will be described with reference to the figures. FIGS. 3 and 4 are schematics views illustrating processes of manufacturing the thin film transistor according to the first exemplary embodiment.

First, as shown in FIG. 3A, a silicon oxide film with a thickness of about 500 nm is formed as an underlying insulting film 11 on the substrate body 10a made of glass or quartz. Next, as shown in FIG. 3B, a semiconductor layer 42 being made of polysilicon is formed in an island shape on the underlying insulating film 11. The semiconductor layer 42 having an island shape may be formed by forming an amorphous silicon layer with a low hydrogen concentration on the underlying insulating film 11 by, for example, a PECVD (Plasma Enhanced Chemical Vapor Deposition) method, crystallizing the amorphous silicon layer into a polysilicon layer by application of excimer laser, etc., and then patterning the polysilicon layer by a photolithography method. Further, before the crystallization of the amorphous silicon into polycrystalline silicon, impurity ions may be implanted into the amorphous silicon layer by ion implantation, such as ion doping, ion implantation, etc., and in this case, the dose may be about 5×10¹²/cm².

Generally, the impurities are P type impurities when the transistor to be manufactured is an N type transistor, and are N type impurities when the transistor to be manufactured is a P type transistor. But the impurity types are not limited to this. The impurity type can be properly changed in accordance with the value which should be set as the threshold value of the transistor.

Next, as shown in FIG. 3C, an insulating thin film (gate insulating film) 2 made of silicon oxide is formed with a predetermined thickness by the PECVD method. Subsequently, a gate electrode thin film 32A made of material, such as Al-Nd, etc. is formed on the insulating thin film 2. Then as shown in FIG. 3C, a resist 38 is patterned thereon.

Next, by using the resist 38 as a mask and by using mixed acid of phosphoric acid, nitric acid, and acetic acid as an etching liquid, the gate electrode thin film is wet-etched, thereby forming a gate electrode in a predetermined flat area. At that time, as shown in FIG. 3D, the gate electrode 32 is formed to have a width smaller than that of the resist 38. Specifically, the above wet-etching is carried out such that a distance Lo between the lower edge of the resist 38 and the edge of the gate electrode 32 is 1 μm.

Next, in the state where the resist 38 is formed, impurities are implanted to the semiconductor layer 42 from the resist 38 side, thereby forming low-concentration regions (n− regions) 1B, 1C into which impurities are introduced with low concentration. Through the introduction of impurities, a semiconductor region 1A including an intrinsic semiconductor (or semiconductor into which impurities are introduced with minute concentration) is formed between the low-concentration regions 1B, 1C. Since the resist 38 is protruded outwardly (in both horizontal directions) from the edges of the gate electrode 32, regions which should become the offset regions 1a1, 1a2 are formed with a length corresponding to the distance Lo at the portions shaded by the resist 38.

Ion doping, ion implantation, and other methods may be used to introduce impurities. The dose for forming the regions 1B, 1C maybe from 10×10¹³/cm² to 8×10¹³/cm², for example, in the case of an N channel transistor (phosphorous ions).

Next, the resist 38 is peeled off, and then as shown in FIG. 4A, a resist 39 is patterned again using the photolithography method. The resist 39 is formed to cover the gate electrode 32 on the semiconductor layer 42 and partially overlap the low-concentration regions 1B, 1C. Specifically, the overlapping length (length shown as LDD) of the low-concentration regions 1B, C shown in FIG. 3C and the resist 39 shown in FIG. 4A is about 0.5 μm to 1.5 μm.

Subsequently, impurities are implanted into the semiconductor layer 42 from the resist 39 side, thereby forming the high-concentration impurity regions (n+ regions) 1d, 1e in the semiconductor layer 42 outside the resist 39. The implantation of impurities can employ ion implantation such as ion doping, ion implantation, etc. The dose to form the high-concentration impurity regions 1d, 1e ranges from 1×10¹⁵/cm² to 10×10¹⁵/cm², for example, in the case of an N channel transistor (phosphorous ions).

In the semiconductor layer 42 of the area masked by the resist 39, as shown in FIG. 4A, the low-concentration impurity regions 1b, 1c having the length Ldd are formed. In the semiconductor layer 42 interposed between the low-concentration impurity regions 1b, 1c, an intrinsic semiconductor region into which impurities are not introduced or a minute-concentration impurity region which is slightly doped with impurities is formed.

Next, the resist 39 is peeled off. Then the impurities introduced into the semiconductor layer 42 are activated by application of excimer laser, etc. to the semiconductor layer 42.

Next, as shown in FIG. 4B, a silicon oxide with a thickness of about 400 nm is formed to cover the gate electrode 32 and the insulating thin film 2. Then an interlayer insulating film 13 is formed thereon. Here, in place of the activation through the application of excimer laser, the impurities introduced into the semiconductor layer 42 may be activated by heating the substrate to about 300° C. using heating such as a heating furnace.

Next, as shown in FIG. 4C, two contact holes 116, 117, penetrating the interlayer insulating film 13 and reaching the high-concentration source region 1d and the high-concentration drain region 1e of the semiconductor layer 42, are formed by the photolithography method. Thereafter, for example, a stacked film of Ti/Al/Ti is formed on the interlayer insulating film 13 by using a film forming method, such as a sputtering method, etc. The stacked film is subsequently patterned by the photolithography method, thereby forming the source electrode 16 and the drain electrode 17 shown in FIG. 4C.

Through the processes described above and shown in FIGS. 3 and 4, it is possible to manufacture the TFT 300 according to the above exemplary embodiment including the offset regions 1a1, 1a2 formed at both sides of the channel region 1a of the semiconductor layer 42, respectively, and the low-concentration source region 1b and the low-concentration drain region 1c formed outside the offset regions 1a1, 1a2, respectively.

In a method of manufacturing the thin film transistor according to this exemplary embodiment, hydrogen processing may be carried out after or during implantation of impurities into the semiconductor layer 42. In this case, for example, a method of applying hydrogen plasma by using an RF plasma apparatus at a substrate temperature of 300° C. to 350° C., or a method of introducing the substrate into a sinter furnace and heating the substrate, similarly to a sinter processing of semiconductor processes, may be employed.

Since the thin film transistor according to an aspect of the present invention includes the offset structure and the LDD structure, the deviation of the lengths (offset length Lo, LDD length Ldd) due to production deviation causes the deviation of the on current. Therefore, by carrying out the hydrogen processing, the crystalline defects of the polycrystalline silicon are compensated for by hydrogen atoms. Thus it is possible to stably secure the on current, so that the insufficient on current due to the production deviation can be compensated for to secure the performance of the thin film transistor.

### Second Exemplary Embodiment

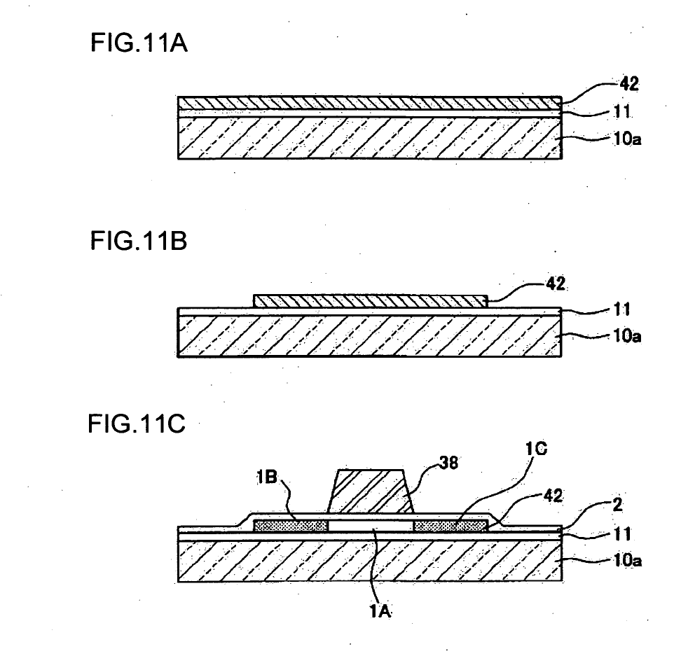

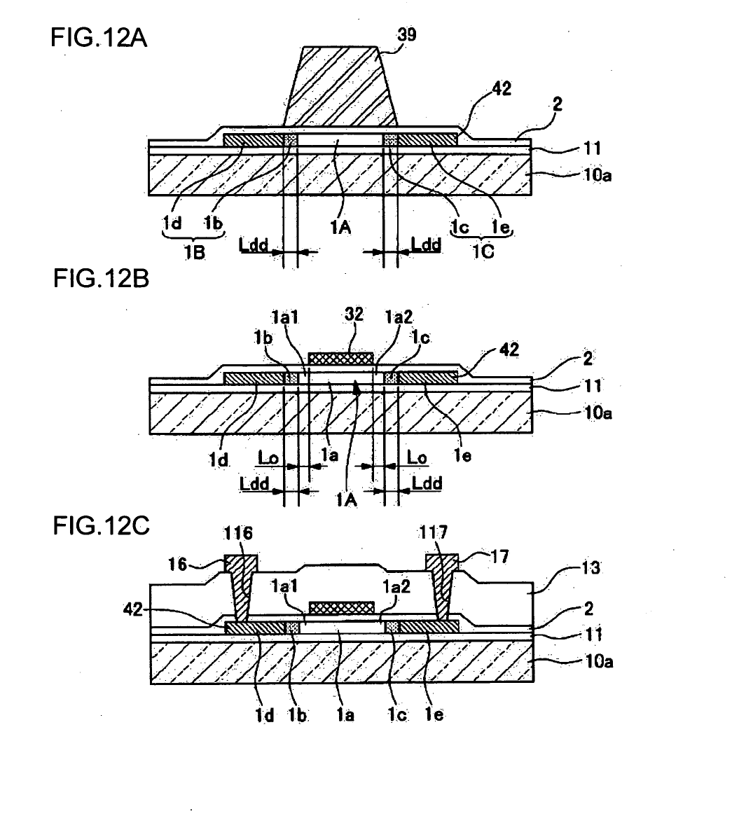

Next, a second exemplary embodiment of a method of manufacturing the thin film transistor according to an aspect of the present invention will be described with reference to FIGS. 11 and 12. FIGS. 11 and 12 are schematics illustrating processes of the manufacturing method according to this exemplary embodiment. In this exemplary embodiment, the method of manufacturing the thin film transistor according to the aforementioned first exemplary embodiment will be described, where the same constituent elements shown in FIGS. 11 and 12 as FIGS. 1 to 4 are denoted by the same reference numerals and descriptions thereof will be omitted.

First, as shown in FIG. 11A, a silicon oxide film with a thickness of about 500 mn is formed as an underlying insulting film 11 on the substrate body 10a made of glass or quartz. Next, as shown in FIG. 11B, a semiconductor layer 42 made of polysilicon is formed in an island shape on the underlying insulating film 11. The semiconductor layer 42 having an island shape can be formed by forming an amorphous silicon layer with low hydrogen concentration on the underlying insulating film 11 by the PECVD (Plasma Enhanced Chemical Vapor Deposition) method, etc., crystallizing the amorphous silicon layer into a polysilicon layer by application of excimer laser, etc., and then patterning the polysilicon layer by a photolithography method. Further, before the crystallization of the amorphous silicon into polycrystalline silicon, impurity ions may be implanted into the amorphous silicon layer by ion implantation, such as ion doping, ion implantation, etc., and in this case, the dose may be about 5×10¹²/cm². It is general that the impurities are P type impurities when the transistor to be manufactured is an N type transistor, and are N type impurities when the transistor to be manufactured is a P type transistor. But the impurity type is not limited to this. The impurity type can be properly changed in accordance with the value which should be set as the threshold value of the transistor.

Next, as shown in FIG. 11C, an insulating thin film (gate insulating film) 2 made of silicon oxide is formed with a predetermined thickness by the PECVD method. Subsequently a resist 38 is patterned at a predetermined position on the semiconductor layer 42.

Next, impurities are implanted into the semiconductor layer 42 by using the resist 38 as a mask. Accordingly, low-concentration regions (n− regions) 1B, 1C into which impurities are implanted with low concentration are formed in the semiconductor layer 42. Further, a semiconductor region 1A made of intrinsic semiconductor (or semiconductor into which impurities are implanted with minute concentration) is formed between the low-concentration regions 1B, 1C. Ion doping, ion implantation, and other methods may be used to introduce impurities. The dose to form the regions 1B, 1C may from 1×10³/cm² to 8×10¹³/cm², for example, in the case of an N channel transistor (phosphorous ions).

Next, the resist 38 is peeled off. Then as shown in FIG. 12A, a resist 39 is formed and patterned again using the photolithography method. The resist 39 is formed to cover the semiconductor region 1 A of the semiconductor layer 42 and partially overlap the low-concentration regions 1B, 1C. Specifically, the overlapping length (Ldd) of the low-concentration regions 1B, 1C shown in FIG. 11C and the resist 39 shown in FIG. 12A is about 0.5 μm to 1.5 μm.

Subsequently, impurities are implanted into the semiconductor layer 42 from the resist 39 side, thereby forming the high-concentration impurity regions (n+ regions) 1d, 1e in the semiconductor layer 42 outside the resist 39. The implantation of impurities can employ ion implantation, such as ion doping, ion implantation, etc. The dose to form the high-concentration impurity regions 1d, 1e ranges from 1×10¹⁵/cm² to 10×10¹⁵/cm², for example, in the case of an N channel transistor (phosphorous ions).

In the semiconductor layer 42 of the area masked by the resist 39, the low-concentration impurity regions 1b, 1c having the length Ldd shown in FIG. 12A are formed. In the semiconductor layer 42 interposed between the low-concentration impurity regions 1b, 1c, an intrinsic semiconductor region into which impurities are not introduced or a minute-concentration impurity region which is slightly doped with impurities, is formed.

Next, the resist 39 is peeled off. Then the impurities introduced into the semiconductor layer 42 are activated by application of excimer laser, etc. to the semiconductor layer 42.

Next, as shown in FIG. 12B, a gate electrode 32 is formed in an area opposing the semiconductor layer via the insulating film 2 therebetween by using the photolithography method, etc. The gate electrode 32 is formed to be apart by a predetermined distance Lo from the edges of the low-concentration impurity regions 1b, 1c at the semiconductor region 1A side. As a result, in the semiconductor region 1A, the channel region 1a opposing the gate electrode 32 is formed. The offset regions 1a1, 1a2, arranged at both sides thereof and not opposing the gate electrode 32, are also formed.

Next, as shown in FIG. 12C, a silicon oxide film with a thickness of about 400 nm is formed to cover the gate electrode 32 and the insulating thin film 2, thereby forming an interlayer insulating film 13. Here, in place of activation by the application of excimer laser, the impurities introduced into the semiconductor layer 42 may be activated by heating the substrate to about 300° C. using heating, such as a heating furnace.

Next, two contact holes 116, 117 penetrating the interlayer insulating film 13 and reaching the high-concentration source region 1d and the high-concentration drain region 1e of the semiconductor layer 42, are formed by the photolithography method. Thereafter, for example, a stacked film of Ti/Al/Ti is formed on the interlayer insulating film 13 by using a film forming method, such as a sputtering method, etc., and the stacked film is subsequently patterned by the photolithography method, thereby forming the source electrode 16 and the drain electrode 17 shown in FIG. 12C.

Through the processes described above and shown in FIGS. 11 and 12, it is possible to manufacture the TFT 300 according to the above exemplary embodiment including the offset regions 1a1, 1a2 formed at both sides of the channel region 1a of the semiconductor layer 42, respectively, and the low-concentration source region 1b and the low-concentration drain region 1c formed outside the offset regions 1a1, 1a2, respectively.

In the method of manufacturing the thin film transistor according to this exemplary embodiment, hydrogen processing may be carried out after or during implantation of impurities into the semiconductor layer 42.

In a method of manufacturing the thin film transistor according to this exemplary embodiment, an annealing process to activate the impurities can be carried out before forming the gate electrode 32. Therefore, the annealing temperature to activate the impurities is restricted by the heat resistant temperature of the material constituting the gate electrode 32, so that it is possible to enhance activation rate of the impurities by raising the annealing temperature. Furthermore, it is also possible to recover the crystalline property of the semiconductor layer 42 deteriorated due to implantation of the impurities.

### Display Device

Next, exemplary embodiments of a display device having the thin film transistor according to an aspect of the present invention will be described. In the following exemplary embodiments, a liquid crystal display device will be exemplified as the display device according to an aspect of the present invention and will be described with reference to the figures.

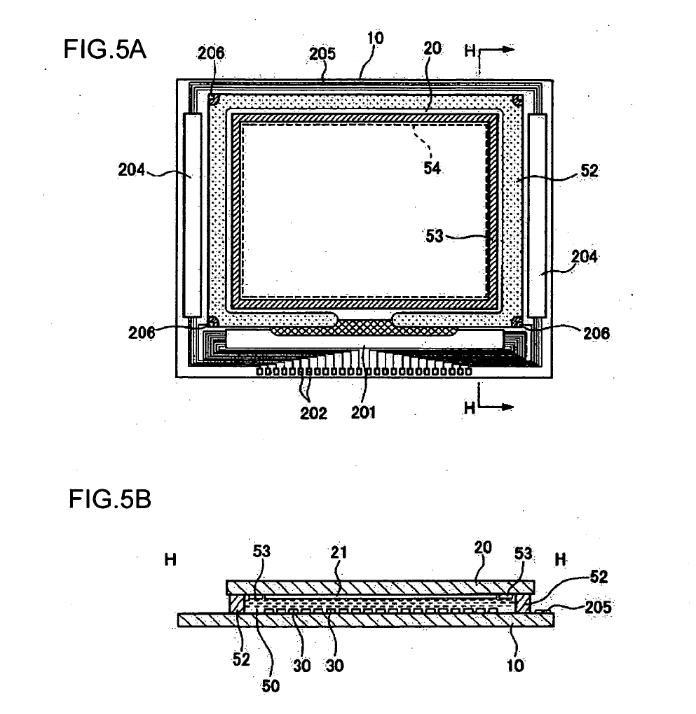

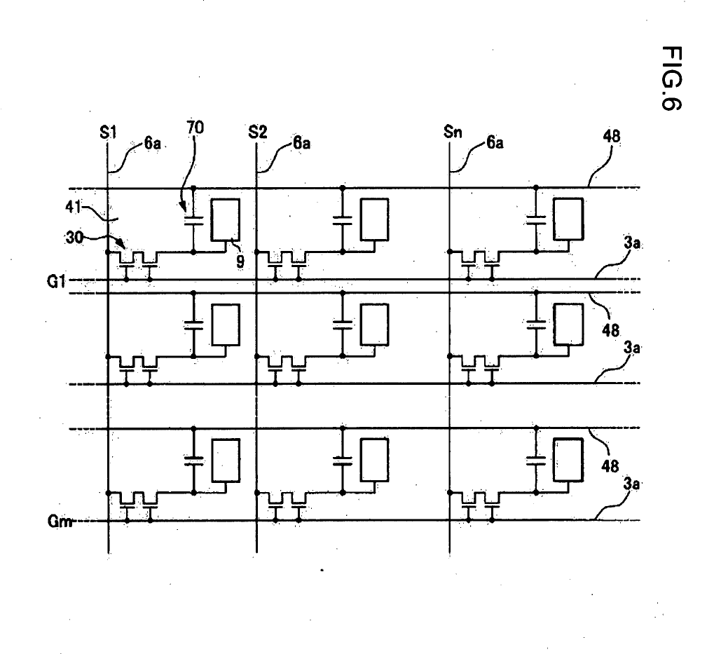

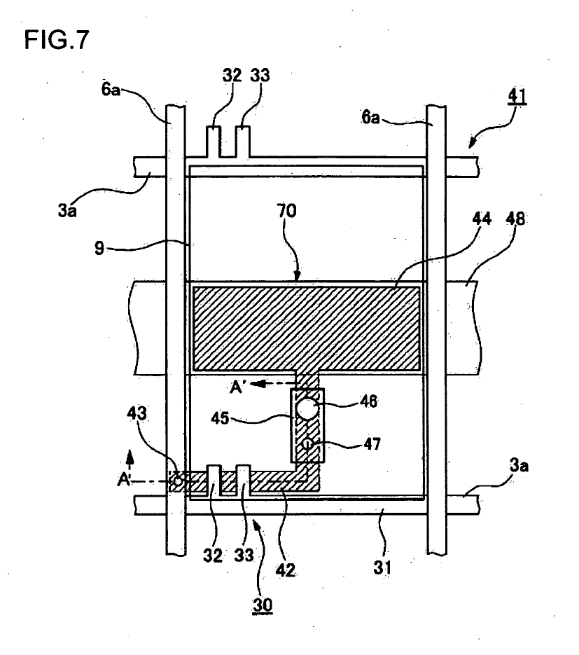

FIG. 5A is a schematic illustrating the liquid crystal display device with constituent elements according to this exemplary embodiment as seen from a counter substrate side, FIG. 5B is a cross-section schematic taken along plane H-H of FIG. 5A, and FIG. 6 is a circuit schematic illustrating a plurality of pixels arranged in a matrix shape in a display area of the liquid crystal display device.

### Overall Configuration of Liquid Crystal Display Device

As shown in FIGS. 5A and 5B, the liquid crystal display device according to this exemplary embodiment has a structure in which a TFT array substrate (active matrix substrate) 10 and a counter substrate 20 are bonded to each other through a seal member 52 having a substantially rectangular frame shape in a plan view. A liquid crystal layer 50 is sealed in an area surrounded with the seal member 52. A peripheral partition 53 having a rectangular frame shape in a plan view is formed along the inner circumferential side of the seal member 52. Thus, an area inside the peripheral partition 53 is defined as an image display area 54. In an area outside the seal member 52, a data line driving circuit 201 and external circuit mounting terminals 202 are formed along one side (the lower side shown in the figure) of the TFT array substrate 10. Scanning line driving circuits 204 are formed along two sides adjacent to the one side. The other side (the upper side shown in the figure) of the TFT array substrate 10 is provided with a plurality of wires 205 to connect the scanning line driving circuits 204 at both sides of the image display area 11 to each other. Further, respective corner portions of the counter substrate 20 are provided with electrical connection members 206 for electrically connecting the TFT array substrate 10 and the counter substrate 20 to each other. The liquid crystal display device according to this exemplary embodiment is implemented as a transmissive liquid crystal display device, and modulates light from a light source (not shown) provided at the TFT array substrate 10 side and outputs the modulated light from the counter substrate 20 side.

Next, in place of providing the data line driving circuit 201 and the scanning line driving circuits 204 on the TFT array substrate 10, terminal groups formed in the peripheral portion of a COF (Chip On Film) substrate mounted with driving LSI and the TFT array substrate 10 may be connected to each other electrically and mechanically through an anisotropic conductive film. Further, in the liquid crystal display device, a phase difference plate, a polarizing plate, etc. are arranged in a predetermined direction in accordance with the kind of liquid crystal to be used, specifically, an operation mode, such as a TN (Twisted Nematic) mode, an STN (Super Twisted Nematic) mode, a vertical alignment mode, etc. or in accordance with a normally white mode or a normally black mode, but they are not shown in the drawings.

In the image display area of the liquid crystal display device having the above structure, as shown in FIG. 6, a plurality of pixels 41 are arranged in a matrix shape and a p-Si TFT 30 to switch a pixel is formed at each of the pixels 41. The TFTs 30 employ a multi gate structure and thus it is possible to reduce the drain-source voltage applied to one TFT of the TFTs 30, compared with a case of employing a single gate structure.

Scanning lines 3a are electrically connected to a plurality of gate electrodes of the TFTs 30, and scanning signals G1, G2, . . . Gm having a pulse shape are line-sequentially applied to the gate electrodes from the scanning lines 3a, in that order, at a predetermined timing. The data lines 6a are electrically connected to the source portions of the TFTs 30, and image signals S1, S2, . . . Sn are supplied thereto within one scanning period.

Pixel electrodes 9 are electrically connected to the drain portions of the TFTs 30, and the image signals S1, S2 . . . Sn supplied from the data lines 6a within one scanning period are written to the respective pixels at a predetermined timing. In this way, the image signals S1, S2, . . . Sn written to the liquid crystal through the pixel electrodes 9 are retained in a space forming along with a common electrode 21 of the counter substrate 20 shown in FIG. 5B for a predetermined time period. Furthermore, in order to reduce the likelihood or prevent the retained image signals S1, S2, . . . Sn from being leaked, retention capacitors 70 are added in parallel to liquid crystal capacitors formed between the pixel electrodes 9 and the common electrode 21.

### Detailed Construction of Pixel

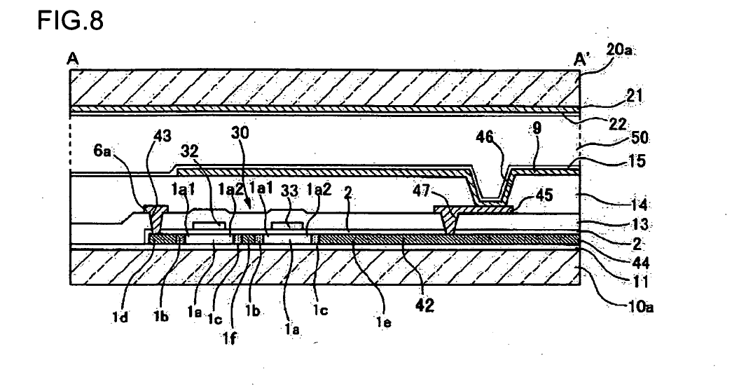

FIG. 7 is a schematic illustrating one pixel area on a TFT array substrate 10 constituting the liquid crystal display device according to this exemplary embodiment. FIG. 8 is a cross-sectional schematic taken along plane A-A′ of FIG. 7.

As shown in FIG. 7, on the TFT array substrate, the data lines 6a and the scanning lines 3a are provided to intersect each other, the pixels 41 are formed by the areas of a substantially rectangular shape defined by the data lines 6a and the scanning lines 3a. Each pixel 41 is provided with a semiconductor layer 42 having a substantially inverted L shape in the plan view. Each scanning line 3a has a main scanning line portion 31 extending in a direction intersecting the data lines 6a and a plurality of (two in FIG. 7) gate electrodes 32, 33 protruded toward the center of each pixel 41 from the main scanning line portion 31. The gate electrodes 32, 33 constitute a TFT having double gate structure by intersecting the portions of the semiconductor layer 42 extending in parallel to the main scanning line body portion 31.

One end of the semiconductor layer 42 is electrically connected to the data line 6a through a source contact hole 43 provided at the intersection with the data line 6a. The other end thereof extends substantially to the central portion of the pixel 41 and is connected integrally to a capacitor electrode 44 having a rectangular shape in a plan view. Further, the capacitor electrode 44 and a capacitor line 48 extending in parallel to the main scanning line portion 31 form the storage capacitor 70 at a portion overlapping each other two-dimensionally.

The pixel electrode 9 having a rectangular shape in a plan view and formed in a flat area substantially overlapping the pixel 41 is made of transparent conductive material, such as ITO, etc., and is electrically connected to a portion of the semiconductor layer 42 extending vertically in the figure through a relay electrode layer 45. Specifically, the pixel electrode 9 and the relay conductive layer 45 are electrically connected to each other through a pixel contact hole 46. The relay conductive layer 45 and the semiconductor layer 42 of the TFT 30 are electrically connected through a drain contact hole 47, whereby the pixel electrode 9 and the TFT 30 are electrically connected each other.

Next, in the cross-sectional structure shown in FIG. 8, in the TFT array substrate 10, the underlying insulating film 11 is formed on one surface of the substrate body 10a made of, for example, quartz, glass, plastic, etc. The TFT 30 is provided on the underlying insulating film 11. The underlying insulating film 11 has a function of suppressing the characteristic deterioration of the TFT 30 due to surface roughness or contamination.

The TFT 30 has a double gate structure as described above, and in the case of this exemplary embodiment, has the LDD structure and the offset structure. Specifically, the TFT 30 includes the gate electrodes 32, 33, two channel regions la formed at areas opposing the gate electrodes 32, 33, an insulating thin film 2 to insulate the gate electrodes 32, 33 from the semiconductor layer 42 to constitute a gate insulating film, and further includes the offset regions 1a1, 1a2 formed at both sides of the two channel regions 1a to constitute the offset structure, the low-concentration source region 1b and the low-concentration drain region 1c formed outside the offset regions 1a1, 11a2 to constitute the LDD portion, the high-concentration source region 1d and the high-concentration drain region 1e formed at both sides of the LDD portion, and a high-concentration source/drain region 1f formed between the channel regions 1a.

The semiconductor layer 42 according to this exemplary embodiment is made of polycrystalline silicon, and for example, phosphorous ions are doped into the respective source/drain regions 1b to 1e in order to form the N channel TFT 30.

The high-concentration drain region 1e of the semiconductor layer 42 extends toward the center portion of the pixel 41 to form the capacitor electrode 44. Further, the capacitor line 48 formed to oppose the capacitor electrode 44 shown in FIG. 7 is formed in the same layer as the scanning lines 3a, and forms the retention capacitor 70 in the opposing area through the insulating thin film 2 shown in FIG. 8.

A first interlayer insulating film 13 is formed to cover the scanning line 3a (and the capacitor line 48), and the data line 6a and the relay conductive layer 45 are formed in the same layer on the first interlayer insulating film 13.

Furthermore, on the high-concentration source region 1d of the semiconductor layer 42, a source contact hole 43 penetrating the first interlayer insulating film 13 is formed. The data line 6a and the high-concentration source region 1d are electrically connected to each other through the source contact hole 43. On the high-concentration drain region 1e, a drain contact hole 47 penetrating the first interlayer insulating film 13 is formed. The relay conductive layer 45 and the high-concentration drain region 1e are electrically connected to each other through the drain contact hole 47.

A second interlayer insulating film 14 is formed to cover the data line 6a and the relay conductive layer 45, and the pixel electrode 9 is formed on the second interlayer insulating film 14. The pixel electrode 9 is made of transparent conductive material, such as ITO, etc. In a flat area of the relay conductive layer 45, a pixel contact hole 46 penetrating the second interlayer insulating film 14 is formed, and the pixel electrode 9 and the relay conductive layer 45 are electrically connected to each other through the pixel contact hole 46. In this way, the high-concentration drain region 1e of the semiconductor layer 42 and the pixel electrode 9 are electrically connected each other through the relay conductive layer 45. Furthermore, a top surface of the TFT array substrate 10 is provided with an alignment film 15 made of a polyimide film, etc. subjected to an alignment process, such as a rubbing process, etc.

The counter substrate 20 includes a common electrode 21 formed in a solid shape at the liquid crystal layer 50 side of a substrate body 20a, and an alignment film 22 formed to cover the common electrode 21. The common electrode 21 can be made of transparent conductive material, such as ITO, etc., and the alignment film 22 can be formed similarly to the alignment film 15 of the TFT array substrate 10. Further, when a color display is performed, color filters including color material layers of, for example, R (red), G (green), and B (blue) may be formed on the substrate body 10a or 20a corresponding to each pixel 41.

In the liquid crystal display device having the above configuration according to this exemplary embodiment, a TFT 30 having a configuration equal to the TFT 300 according to the aforementioned exemplary embodiment is provided as the pixel switching TFT element. The TFT 30 accomplishes the reduction of the off current, compared with the related art TFT having the offset structure, so is less influenced by hot carriers than the related art TFT having the LDD structure. Therefore, according to the liquid crystal display device according to this exemplary embodiment, it is possible to obtain an excellent retention characteristic and excellent reliability, even when the liquid crystal capacity of the pixel becomes smaller. It is also possible to implement a liquid crystal display device which can cope with ultra high precision of, for example, 400 ppi or more.

Furthermore, in this exemplary embodiment, the TFT having the double gate structure has been exemplified, but the present invention is not limited to this. A triple gate, quadruple gate, or more gate structure may be employed. The shapes of the shown patterns or the sectional structure and the constituent materials for the respective films are described only as examples, and can be changed properly.

### Peripheral Circuits

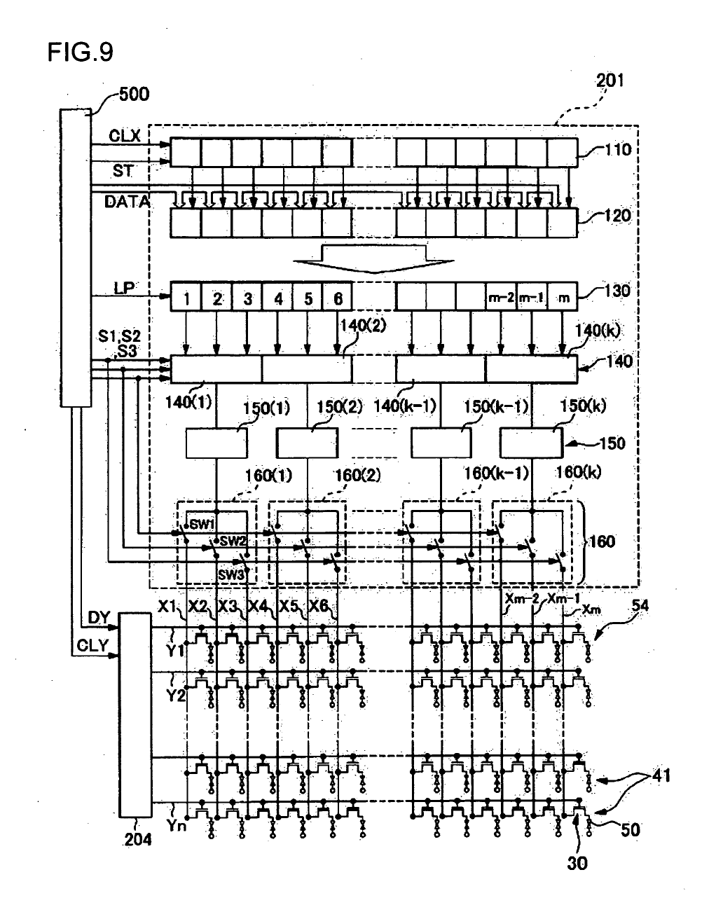

The thin film transistor 300, 310 according to the above embodiments can be applied to peripheral circuits of a display device. Hereinafter, a construction of the peripheral circuits in which the thin film transistor according to an aspect of the present invention can be suitably used will be described with reference to FIG. 9.

FIG. 9 is a schematic illustrating a circuit constitution of the TFT array substrate 10, the data line driving circuit 201, and the scanning line driving circuit 204. In FIG. 9, a reference numeral 110 denotes a shift register, a reference numeral 120 denotes a first latch circuit, a reference numeral 130 denotes a second latch circuit, a reference numeral 140 denotes a selection section, a reference numeral 150 denotes a driver section, a reference numeral 160 denotes a multiplexer circuit, and these circuits constitute the data line driving circuit 201 shown in FIG. 5. The scanning line driving circuit 204 is connected to the image display area 54 through n scanning lines Y1, Y2, . . . , Yn.

In the image display area 54, a pixel matrix having n rows and m columns (n and m are integers) is formed, and the respective pixels 41, . . . are connected to the data line driving circuit 201 and the scanning line driving circuit 204 through wires. Further, the data line driving circuit 201 and the scanning line driving circuit 204 are electrically connected to an external control circuit 500, and the image display area 54 is driven on the basis of image data or timing signals supplied from the external control circuit 500.

From the external control circuit 500, as shown in FIG. 9, image data DATA, a latch timing signal LP, a start signal for the shift register, a data clock signal CLX, and selection signals S1, S2, S3 are supplied to the data line driving circuit 201. A start signal DY and a line shift signal CLY are supplied to the scanning line driving circuit 204.

The clock signal CLX and the start signal ST are input to the shift register 110. The start signal ST is sequentially shifted in the shift register 110 in response to the clock signal CLX. Output signals from the respective unit registers in the shift register 110 are input to the respective unit latch circuit in the first latch circuit 120. The image data DATA as image signals are supplied simultaneously to all the unit latch circuits. If the output signals from the unit registers are input, the image data DATA are sequentially stored in the respective unit latch circuits of the first latch circuit 120. The image data DATA are, for example, digital signals of six bits. Therefore, m image data by one line, that is, one horizontal scanning line are stored in the first latch circuit 120.

The second latch circuit 130 is a circuit to latch the image data DATA of the first latch circuit 120 as it is. Therefore, m data which are data by one line are latched in the second latch circuit 130.

The selection section 140 includes a plurality of selector circuits 140(1), 140(2), . . . 140(k). The image data DATA by one line are divided into groups of three successive data from a front end or a rear end of the data by one line, thereby forming a plurality of groups. The three data of each group are input to the corresponding selector circuit. Specifically, 1, 2, 3 of the image data DATA are input to the selector circuit 140(1), 4, 5, 6 of the image data DATA are input to the selector circuit 140(2), and m-2, m-1, m of the image data DATA are input to the selector circuit 140(m).

The selection signals S1, S2, S3 are supplied to the selection section 140, and the respective selector circuits 140(1) to 140(k) select one predetermined image data of the three input image data as an output signal in response to the selection signals S1, S2, S3 and supply the output signal to a driver circuit corresponding to the driver section 150.

The driver section 150 includes a plurality of driver circuits 150(1), 150(2), . . . , 150(k). For example, when the selection signal SI is supplied, the image data DATA[1] is output to the driver circuit 150(1) from the selector circuit 140(1), the image data DATA[4] is output to the driver circuit 150(2) from the selector circuit 140(2), and the image data DATA[m-2] is output to the driver circuit 150(k) from the selector circuit 140(k). Each driver circuit includes a digital-analog converter, an amplifier circuit, etc.

The image signal from each driver circuit converted into the analog signal is supplied to the corresponding multiplexer circuit of the multiplexer section 160 through the source line group 7. The multiplexer section 160 includes a plurality of multiplexer circuits 160(1), 106(2), . . . 160(k). Each multiplexer circuit has three switch circuits SW1, SW2, SW3. The image signal supplied from each driver circuit is supplied to one end of the three switch circuits SW1, SW2, SW3 of the corresponding multiplexer circuit. The other ends of the respective switch circuits, which are output sides, are connected to the corresponding data lines of the data line group X1 to Xm in the X direction of the image display area 54. The selection signals S1, S2, S3, to turn on or off the respective switch circuits, are supplied to the multiplexer section 160. The multiplexer section 160 turns on one of the predetermined switch circuits SW1 to SW3 in response to the selection signals S1, S2, S3, and supplies the image signal supplied from the driver circuit to a predetermined data line.

For example, when the selection signal S1 is supplied, the switch circuit SW1 of the multiplexer circuit 160(1) is turned on. Thus the image signal corresponding to the image data DATA[1] is output to the data line X1. Similarly, the switch circuit SW1 of the multiplexer circuit 160(2) is turned on. Thus the image signal corresponding to the image data DATA[4] is output to the data line X4. Similarly, the switch circuit SW1 of the multiplexer circuit 160(k) is turned on. Thus the image signal corresponding to the image data DATA[m-2] is output to the data line Xm-2.

For example, when the selection signal S2 is supplied, the switch circuit SW2 of the multiplexer circuit 160(1) is turned on. Thus the image signal corresponding to the image data DATA[2] is output to the data line X2. Similarly, the switch circuit SW2 of the multiplexer circuit 160(2) is turned on and thus the image signal corresponding to the image data DATA[5] is output to the data line X5. Similarly, the switch circuit SW2 of the multiplexer circuit 160(k) is turned on and thus the image signal corresponding to the image data DATA[m-1] is output to the data line Xm-1.

Furthermore, when the selection signal S3 is supplied, the switch circuit SW3 of the multiplexer circuit 160(1) is turned on. Thus the image signal corresponding to the image data DATA[3] is output to the data line X3. Similarly, the switch circuit SW3 of the multiplexer circuit 160(2) is turned on and thus the image signal corresponding to the image data DATA[6] is output to the data line X6. Similarly, the switch circuit SW3 of the multiplexer circuit 160(k) is turned on and thus the image signal corresponding to the image data DATA[m] is output to the data line X.

As described above, the respective multiplexer circuits sequentially select the image signals from the respective driver circuits by turning on the predetermined switch circuits correspondingly to the selection signals, and outputs the selected signals to the corresponding source lines. At that time, since the selection signals simultaneously turn on the predetermined switch circuits of the respective multiplexer circuits, the outputs of the respective multiplexer circuits are simultaneously supplied to the corresponding source lines.

In the above description, although it has been described that three outputs of the latch circuits are classified into one group and the outputs of the multiplexer circuit are three, the present invention is not limited to this. Two outputs or more outputs may be classified into one group in the latch circuits and the multiplexer circuits. In this case, the selection signals of kinds corresponding to the number of outputs included in one group are supplied to the selection section and the multiplexer section.

The thin film transistor according to the above exemplary embodiment can be suitably used for the switch circuits SW1 to SW3 of the multiplexer circuits 160. The thin film transistor according to an aspect of the present invention has an advantage of reduced off current and small hot carrier deterioration, and is thus suitable for the multiplexer circuits 160 connected directly to the pixels 41 of the image display area 54. If the on current of the TFT is reduced due to the production deviation, the on current of the polysilicon TFT is several times larger than that of the amorphous silicon TFT, so that the current supply is not insufficient in the multiplexer circuit having a small ratio, such as 1:3 multiplexer circuits 160 shown in FIG. 9.

Furthermore, if the pixels have an ultra high precision, the liquid crystal capacity of the pixels is inversely proportional to the square of a pitch. Thus a margin is generated in the current supply, so that by increasing the ratio of the multiplexer circuit 160, it is possible to enhance the degree of integration of the peripheral circuits. The reduction of the off current, which causes a problem in the ultra high precision, can be addressed by applying the present invention.

### Projection Display Apparatus

Next, a projection display apparatus as an example of an electronic apparatus includes the aforementioned liquid crystal display device will be described.

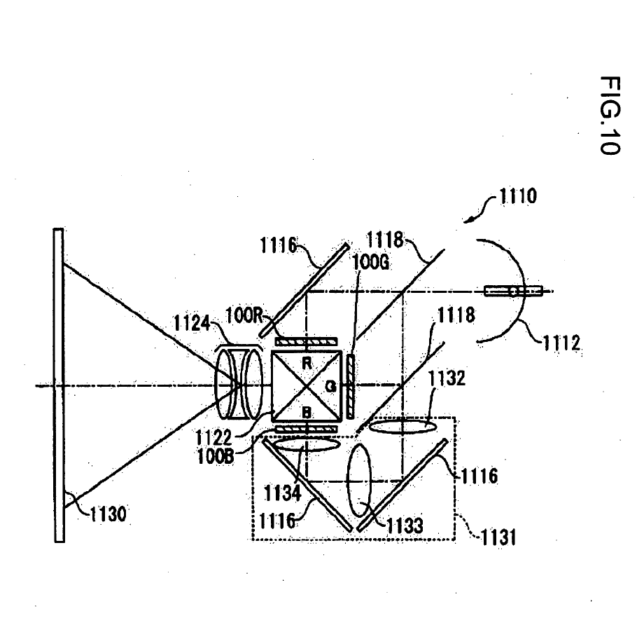

FIG. 10 is a schematic illustrating a construction of a projection display apparatus including the aforementioned liquid crystal display device as a light valve. The projection liquid crystal display apparatus 1110 is constructed as a three-plate projector employing the liquid crystal display devices as light valves 100R, 100G and 100B for R, G and B. In the liquid crystal projector 1110, when light is output from a lamp unit 1112 which is a white light source, such as a metal halide lamp, the light is divided into three light components R, G, B corresponding to three primary colors of R, G, B through three sheets of mirrors 1116 and two sheets dichroic mirrors 1118 (light division means), and guided into the corresponding light valves 100R, 100G, 100B (liquid crystal devices/liquid crystal light valves), respectively. At that time, since the light component B has a long optical path, the light component B is guided through a relay lens system 1131 including an input lens 1132, a relay lens 1133, and an output lens 1134 in order to reduce or prevent light loss. The light components R, G, B corresponding to the three primary colors modulated through the light valves 100R, 100G, 100B, respectively, are input to a dichroic prism 1122 (light synthesizing device) from three ways, and are synthesized again therein, and then the synthesized light is enlarged and projected to a screen 1130, etc. through a projection lens (projection optical system) 1124 as a color image.

Since the projection display apparatus employs a liquid crystal display device in which the off-leak current of transistors has been reduced to a very low level, it is possible to realize ultra high-precision display of 400 ppi class.

The present invention is not limited to the above exemplary embodiments, but may be modified and implemented variously without departing from the spirit and scope of the present invention. The active matrix substrate according to an aspect of the present invention is not limited to the liquid crystal display device, but may be applied suitably to, for example, a display device employing electroluminescence (EL), plasma luminescence, or fluorescence due to electron emission, or a display device employing a digital micro mirror device (DMD), and an electronic apparatus including the above display devices.

1. A thin film transistor, comprising:
an insulating substrate;
a semiconductor layer provided on the insulating substrate;
a gate electrode;
a drain electrode; and
a source electrode, the gate electrode and the drain electrode being connected to the semiconductor layer, the semiconductor layer including:
a high-concentration impurity region which is connected to the drain electrode and which is highly doped with an impurity;
a low-concentration impurity region which is provided at a gate electrode side of the high-concentration impurity region and which is lowly doped with an impurity; and
an offset region which is a region slightly doped with an impurity or which is an intrinsic semiconductor region, the offset region being provided at a gate electrode side of the low-concentration impurity region.

2. The thin film transistor according to claim 1, the thin film transistor being an N type in which the high-concentration impurity region is highly doped with N type impurities, the low-concentration impurity region is lowly doped with N type impurities, and the offset region is slightly doped with P type impurities or the intrinsic semiconductor region.

3. The thin film transistor according to claim 1, the thin film transistor being of a P type in which the high-concentration impurity region is highly doped with P type impurities, the low-concentration impurity region is lowly doped with P type impurities, and the offset region is slightly doped with N type impurities or the intrinsic semiconductor region.

4. The thin film transistor according to claim 1, further comprising:
a second gate electrode which is connected electrically to the gate electrode and two-dimensionally covers the offset region of the semiconductor layer.

5. The thin film transistor according to claim 4, the second gate electrode being formed inwardly from the high-concentration impurity region.

6. The thin film transistor according to claim 1, the thin film transistor further comprising:
a plurality of gate electrodes.

7. An active matrix substrate, comprising:
the thin film transistor according to claim 1.

8. A display device, comprising:
the active matrix substrate according to claim 7.

9. A display device, comprising:
a plurality of scanning lines;
a plurality of data lines;
thin film transistors and pixel electrodes arranged at intersections of the plurality of scanning lines; and the plurality of data lines;
a data line driving circuit to supply data to the plurality of data lines; and
a scanning line driving circuit to supply scanning signals to the plurality of scanning lines, the data line driving circuit having a multiplexer circuit to selectively output image signals from an image signal line to the plurality of data lines in response to a selection signal, and the thin film transistors arranged at intersections of the plurality of scanning lines and the plurality of data lines being the thin film transistor according to claim 1.

10. A display device, comprising:
a plurality of scanning lines;
a plurality of data lines;
thin film transistors and pixel electrodes arranged at intersections of the plurality of scanning lines and the plurality of data lines;
a data line driving circuit to supply data to the plurality of data lines; and
a scanning line driving circuit to supply scanning signals to the plurality of scanning lines,
the data line driving circuit having a multiplexer circuit to selectively output image signals from an image signal line to the plurality of data lines in response to a selection signal, and a thin film transistor of the multiplexer circuit being the thin film transistor according to any claim 1.

11. An electronic apparatus, comprising:
the display device according to claim 8.
